(19) United States
(12) Patent Application Publication
(10) Pub. No.: US 2008/0088673 A1
(43) Pub. Date: Apr. 17, 2008

(54) METHOD OF PRODUCING INKJET CHANNELS USING PHOTOIMAGEABLE MATERIALS AND INKJET PRINTHEAD PRODUCED THEREBY

(76) Inventor: Richard W. Sexton, Bainbridge, OH (US)

Correspondence Address: David A. Novais;Patent Legal Staff, Eastman Kodak Company, 343 State Street, Rochester, NY, 14650-2201, US

(21) Appl. No.: 11/550,011

(22) Filed: Oct. 17, 2006

(51) Int. Cl. B41J 2/04

(52) U.S. Cl. 347/54

(57) ABSTRACT

A method of forming respective ink channels upon a substrate having respective actuators has a first layer of uncured photoresist material of a first type deposited onto a substrate incorporating the actuators. The first type of photoresist material is exposed to form cured and uncured areas wherein the uncured areas comprise the respective ink channels with respective orifices from which ink is to be ejected. A second layer of photoresist material of a second type is deposited over the cured and uncured areas of the first type of photoresist material and then exposed to provide uncured areas representing the respective orifices from which the ink is to be ejected and cured areas comprising channel walls for the respective ink channels. The second layer is developed with a first developer that is suitable for developing the second layer but not suitable for developing the first layer. The first layer is developed with a second developer that is suitable for developing the first layer but not suitable for developing the second layer. The undeveloped material in the first layer is removed to form the respective ink channels with respective orifices for ejecting the ink.

### FIELD OF THE INVENTION

The invention relates generally to field of inkjet recording heads, and in particular to a method of manufacturing an inkjet recording heads. More particularly, the invention relates to the manufacture of inkjet recording heads having ink recording channels formed using photoimageable materials.

### BACKGROUND OF THE INVENTION

Inkjet printing has gained popularity in a number of applications. One of the growing printing applications is in the printing of billboards, banners and point of sale displays as well as photographic images. The inkjet printing process involves manipulation of drops of ink ejected from an orifice or a number of orifices of a printhead onto an adjacent print medium or substrate.

Fluid ejectors have been developed for ink jet recording or printing. Inkjet printing systems offer numerous benefits including extremely quiet operation when printing, high speed printing, a high degree of freedom in ink selection, and the ability to use low cost plain paper. The so called “drop on demand” drive method, where ink is output only when required for printing, is now the conventional approach. The drop on demand drive method makes it unnecessary to recover ink not needed for printing.

Fluid ejectors for inkjet printing include one or more nozzles or ink ejecting orifices which allow the formation and control of small ink droplets to permit high resolution, resulting in the ability to print sharper characters with improved tonal resolution. In particular, drop on demand inkjet printheads are generally used for high resolution printers.

Drop on demand technology generally uses some type of pulse generator to form and eject drops. For example, in one type of print head, a chamber having an ink nozzle may be fitted with a piezoelectric wall that is deformed when a voltage is applied. As a result of the deformation, the fluid is forced out of the nozzle orifice as a drop. The drop then impinges directly on an associated printing surface. Similarly, a membrane may be actuated in response to a deformation of an actuator comprising a piezoelectric wall.

Another type of print head uses bubbles formed by heat pulses generated by selectively enabling the generating actuators to force fluid out of the nozzle. The drops are separated from the ink supply when the bubbles form.

Yet another type of drop-on-demand printhead incorporates an electrostatic actuator. This type of print head utilizes electrostatic force to eject the ink. Inkjet printheads of this type use an electrostatic actuator comprising a diaphragm that constitutes a part of an ink ejection chamber and a base plate disposed outside of the ink ejection chamber opposite to the diaphragm. The inkjet head ejects ink droplets through a nozzle communicating with the ink ejection chamber by applying a time varying voltage between the diaphragm and the base plate. The diaphragm and the base plate thus act as a capacitor, which causes the diaphragm to be set into mechanical motion and the fluid to exit responsive to the diaphragm's motion.

Still another type of inkjet drop on demand printhead uses lasers to heat the whole ink body of the droplet. In particular a laser called a Vertical Cavity Surface Emitting Laser diode, VCSEL, have been made by formation of semiconductor micro fabrication on the surface of silicon wafers. Because the VCSELs are surface devices they are amenable to monolithic construction of channels and reservoirs over the lasers on the silicon wafer surface. Examples of such devices may be found in U.S. Pat. No. 7,025,442. Because of the microscopic size of these lasers, very small droplets of pixel size can be ejected.

Fluid drop ejectors may be used not only for printing, but also for depositing other materials such as photoresist and other liquids in the semiconductor and flat panel display industries, for decorating and/or printing on foods, for delivering drug and biological samples, for delivering multiple chemicals for chemical reactions, for handling DNA sequences, for delivering drugs and biological materials for interaction studies and assaying, and for depositing thin and narrow layers of plastics for use as permanent and/or removable gaskets in micro machines. The term “ink” as used herein refers generically to any liquid or ejectable material such as a slurry that is ejected from nozzle or orifice openings of a printer for purposes of being deposited upon a substrate to be selectively coated in accordance with “image-related” or “image-like” signals.

An inkjet printhead comprises an array or a matrix of ink channels or cavities each ending with an ink ejection orifice or nozzle. The nozzles of an array or a matrix of ink channels are typically made on a common substrate called a nozzle or orifice plate. Usually, the nozzle plate surface is attached to an array or a matrix of ink channels in a way that each nozzle faces a corresponding ink channel. The other surface is an “open” surface that faces the printed media or substrate. Each nozzle selectively ejects ink droplets in the direction of the printing substrate. A given nozzle of the print head ejects the ink droplet in a predefined print position on the media. An assembly of the adjacently positioned on the media ink droplets creates a predetermined print pattern or image. Relative movement between the media or substrate and the printhead enables printing so as to obtain substrate coverage of the ink or other printing medium and image creation. The selection of printing media is large and varies from paper and fabric to metal and glass.

In the prior art as exemplified by the U.S. Pat. No. 5,478,606 there is disclosed a method of manufacturing an inkjet recording head wherein an ink flow path pattern is first formed using a dissoluble resin and then there is formed an overlying second layer that defines the ink chamber or ink channel walls. The ink flow path pattern is then dissolved to establish the inkjet channel walls. The problem with this approach, and indeed such is noted in the patent itself, is that special coating methods are required in order to coat the second layer upon the previously formed ink flow path pattern in order to provide a uniform coating of the overlying second layer.

In U.S. Pat. No. 7,029,099 there is described a method for creating inkjet channel walls using photoimageable materials wherein through selective masking and exposure steps a single photoimageable layer may be formed with ink channel walls and ink ejection openings. While this approach reduces complexity and manufacturing steps it may not be as accurate in controlling dimensions of the ink channel walls.

Consequently, a need exists for a method of forming an inkjet printhead having inkjet channels which provides for improved control in the forming of inkjet channel wall structures and reduces complexity in the manufacture of such structures.

### SUMMARY OF THE INVENTION

In accordance with the invention there is provided a method of forming respective ink channels upon a substrate having respective actuators for providing energy to eject ink from the respective channels, the method comprising the steps of (a) depositing a first layer of uncured photoresist material of a first type onto a substrate incorporating the actuators; (b) selectively exposing the first type of photoresist material on the substrate to form cured and uncured areas in the first type of photoresist material, wherein the uncured areas comprise the respective ink channels with respective orifices from which ink is to be ejected; (c) depositing a second layer of photoresist material of a second type over the cured and uncured areas of the first type of photoresist material formed in step (b); (d) selectively exposing the second type of photoresist material so as to provide uncured areas representing the respective orifices from which the ink is to be ejected and cured areas comprising channel walls for the respective ink channels; (e) developing the second layer with a first developer that is suitable for developing the second layer but not suitable for developing the first layer; (f) subsequent to step (e), developing the first layer with a second developer that is suitable for developing the first layer but not suitable for developing the second layer; and (g) removing the undeveloped material in the first layer to form the respective ink channels with respective orifices for ejecting the ink.

The above and other objects of the present invention will become more apparent when taken in conjunction with the following description and drawings wherein identical reference numerals have been used, where possible, to designate identical elements that are common to the figures.

### BRIEF DESCRIPTION OF THE DRAWINGS

While the specification concludes with claims particularly pointing out and distinctly claiming the subject matter of the present invention, it is believed the invention will be better understood from the following detailed description when taken in conjunction with the accompanying drawings.

FIG. 1 illustrates a schematic diagram of an exemplary drop on demand ink jet print head and nozzle array as a print medium (e.g. paper) rolls under the ink jet printhead.

FIG. 2 is a top view of an array of four VCSEL actuators forming part of a substrate that includes the VCSEL array and upon which ink channels with ink ejecting orifices will be formed in accordance with the invention to provide an improved inkjet printhead.

FIG. 3 is a cross-section, relatively simplified to facilitate understanding of the invention, of a portion of the substrate shown in FIG. 2.

FIG. 4 is a cross-sectional view similar to that of FIG. 3 and showing a thin protective layer applied to the surface of the VCSEL array.

FIG. 5 is a cross-sectional view similar to that of FIG. 4 and illustrating selective exposure of a first photoresist layer that is deposited upon the thin protective layer.

FIG. 6 is a top view of the structure shown in FIG. 5 and showing more clearly an ink channel being formed by the selective exposure of the first photoresist layer.

FIG. 7 is a view similar to that of FIG. 5 and illustrating exposure of a second photoresist layer that is deposited upon the first photoresist layer and selective exposure thereof.

FIG. 8 is a cross-sectional view of the structure shown in FIG. 7 after respective developments of the first and second layers and the view taken to also show the ink channel that is formed in the first layer.

FIG. 9 is a top view of the structure shown in FIG. 8.

FIG. 10 is a view similar to that of FIG. 8 and illustrating formation of an ink drop in operation of the inkjet printhead formed in accordance with the invention.

### DETAILED DESCRIPTION OF THE INVENTION

This description will be directed in particular to elements forming part of or cooperating more directly with apparatus in accordance with the present invention. It is to be understood that elements not specifically shown or described may take various forms well known to those skilled in the art.

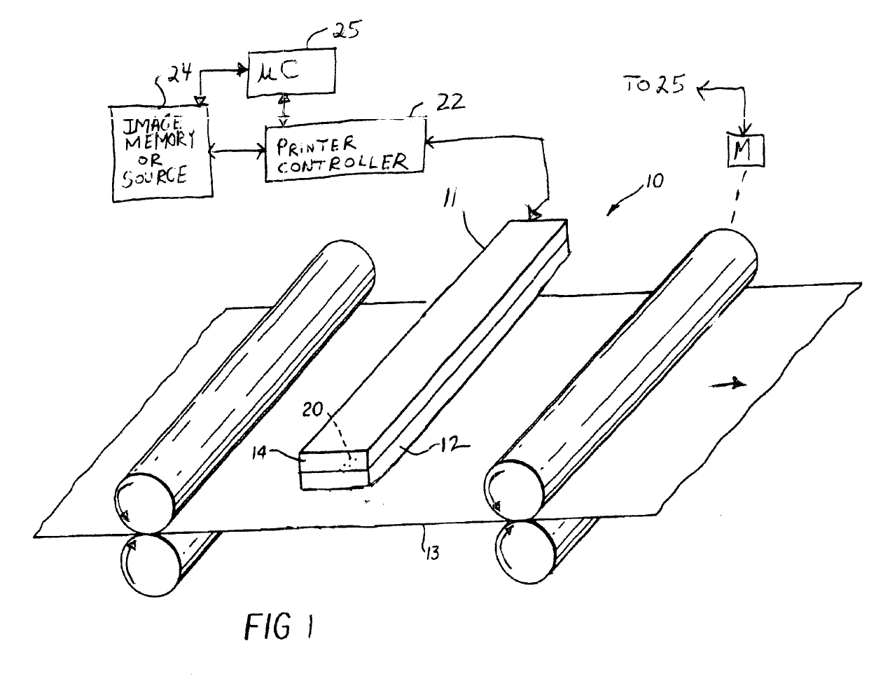

Referring to FIG. 1, an on-demand inkjet printer system is generally shown at 10. The printer system includes a printhead 11, from which extends an array of nozzles 20, incorporating control circuits (not shown).

The printer controller 22 reads data from an image memory or image source 24, and sends time-sequenced electrical pulses to the printhead 11 including the actuators of the nozzles or orifices of nozzle array 20. These pulses are applied for an appropriate length of time, and to the appropriate nozzle, so that drops or droplets of ink form at selective nozzle openings or orifices from the body of ink located within each of respective ink channels or chambers associated with the respective orifices and will form spots on a recording medium 13, in the appropriate position designated by the data sent from the image memory. Ink is supplied from an ink reservoir (not shown) to an ink delivery structure 12 having ink channels formed upon a substrate 14 comprised of the actuators as will be described herein and through nozzle array 20 on to the recording medium 13. Overall control of the generation of data and timing signals for selectively actuating the respective actuators for selective ejection of ink from the respective orifices and movement of the recording medium 13 such as by advancement of the recording medium by a suitable motive means (M) relative to the printhead may be provided by a microcontroller 25 such as a suitably programmed microcomputer. Programming of such computers are well known in the prior art.

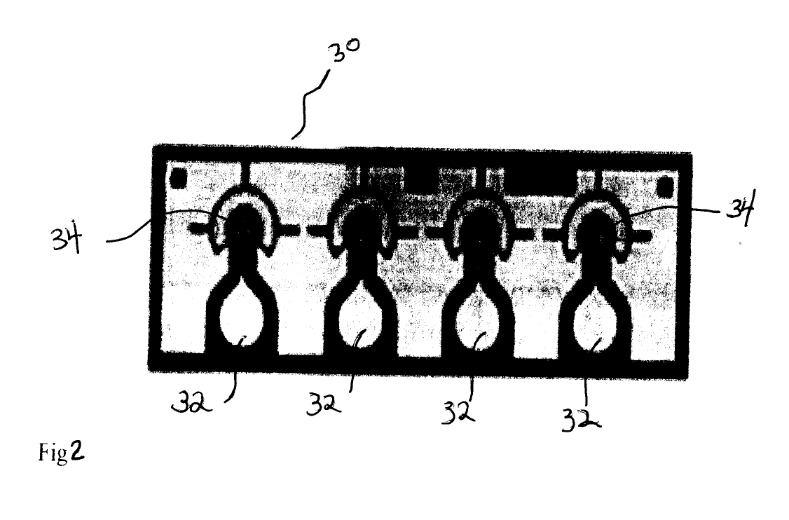

With reference now to FIG. 2 there is illustrated an array of preferred actuators 30 that are in the form of VCSEL laser devices, four of which are shown. Each of the actuators includes a respective electrical contact 32 that is connected to the printer controller 22 and upon which electrical signals are provided for determining the time of actuation of the respective nozzle for ejection of a respective ink drop onto the recording or receiver medium 13. Each VCSEL includes a window 34 through which laser light is generated and directed to impinge upon the body of ink liquid formed in the channel directly overlying the respective window to form the ink droplet as is known in the prior art, see U.S. Pat. No. 7,025,442. As an example, the laser may emit infrared radiation at 850 nm, a wavelength suitable for heating color solutions. Of course, the wavelength of the radiation may be made suitable for the particular body of liquid to be ejected. Semiconductor lasers in single units were in multi-laser arrays are commercially available from Honeywell Inc. or Emcore Corp. Lasers having diameters of 10 micrometers to 15 micrometers may be suitable for imparting sufficient energy to ink to form tiny droplets of fluid for droplet ejection. The output power of VCSELs may be, for example, between 2 milliwatts and 5 milliwatts and can provide sufficient heat energy to boil controlled volumes (e.g. 10 micrometers to 15 micrometers droplets) in about 2 milliseconds to 25 milliseconds. As noted above, the term “ink” may refer more broadly to liquid substances or slurries other than conventional inks for the uses referred to above.

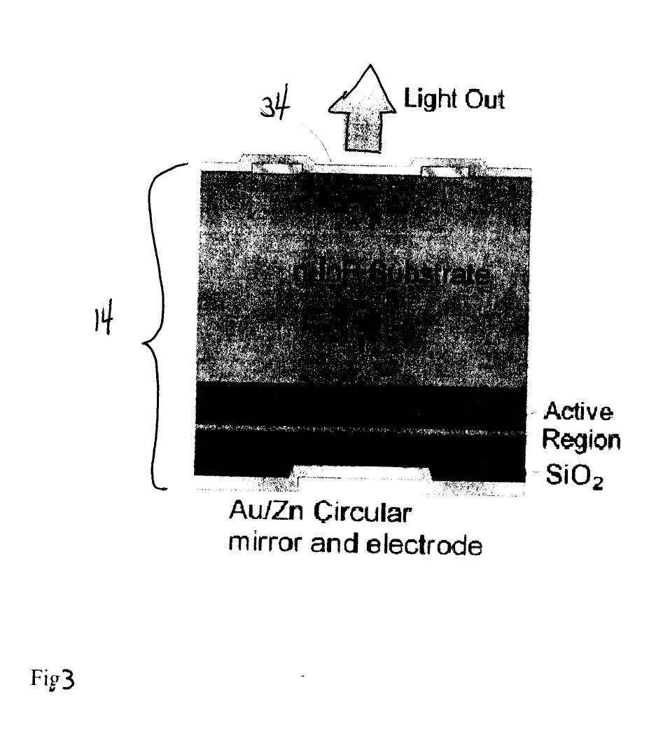

With reference now to FIG. 3 a cross-section of the actuator containing substrate 14 upon which a respective VCSEL laser diode actuator is formed comprises a semiconductor substrate formed of a plurality of selectively doped layers that define distinct laser diode actuators 30 that may be arranged in one or more lines. Each actuator includes a respective window 34 through which laser light may be emitted when the actuator is enabled through presentation of an appropriate electrical pulse at a respective electrical contact 32.

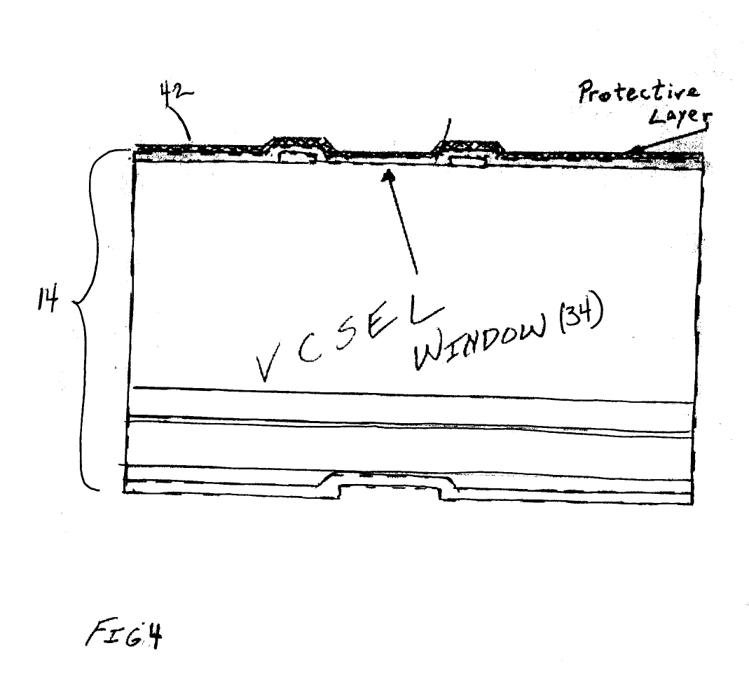

With reference now to FIG. 4 the array of laser diode actuators 30 are first coated with a one micrometer thick protective layer 42 such as a polymerized epoxy based photoresist, SU-8 2000, made by Micro-Chem Co., of Newton, Mass. As will be shown below this thin layer separates the liquid ink from the laser window 34. In forming this protective layer 42, openings may be provided therein through selective masking, to allow connections to the electrical contacts 32.

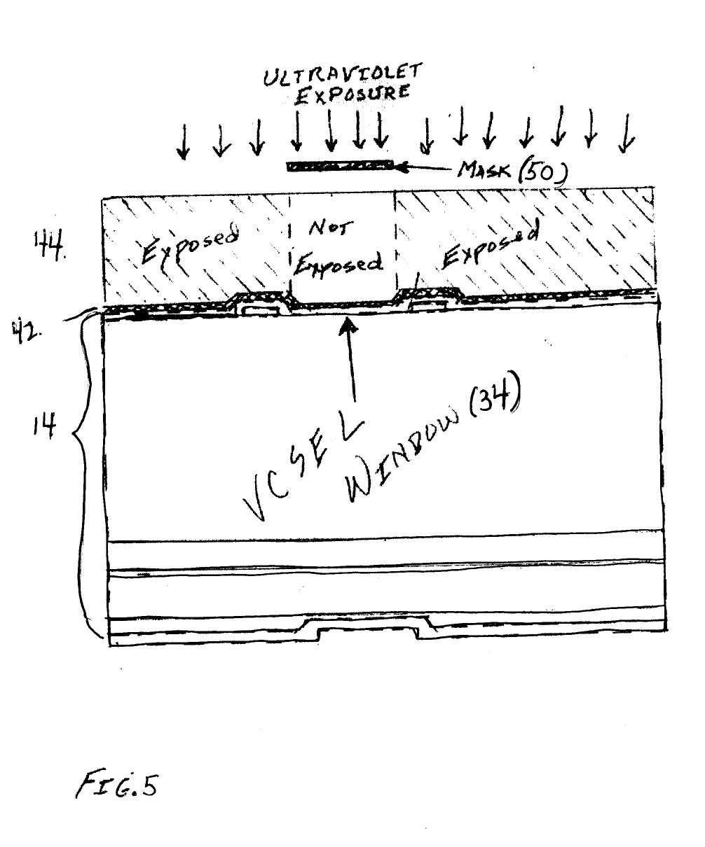

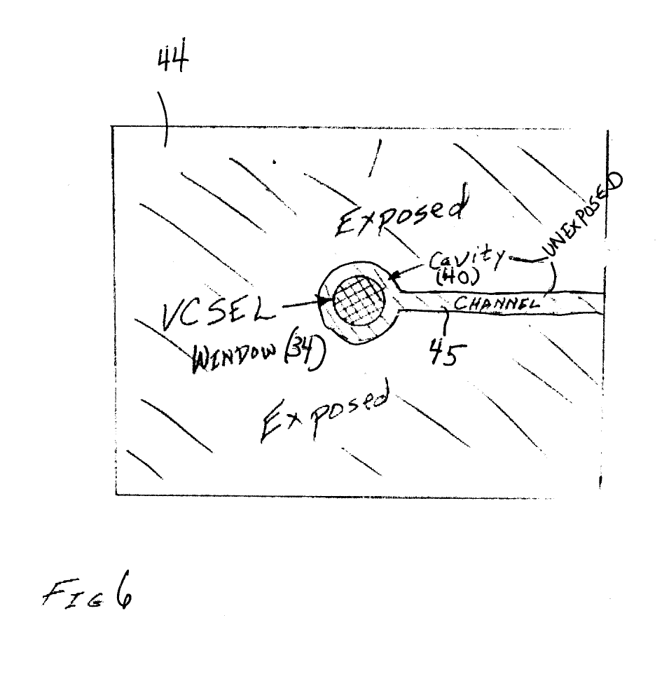

To create an ink ejection chamber and ink supply, plastic-forming micro-photoresists are used to make the necessary “plumbing,” in-situ, on top of the laser diode actuators. With reference now to FIG. 5 a generally uniform thick layer 44 of photoresist, from 10 micrometers to 25 micrometers in thickness, is coated onto the surface of the actuator containing substrate 14 and over the protective layer 42. This layer may also comprise the SU-8 2000 photoresist, which is a negative acting photosensitive resist. After depositing the layer 44 of photoresist, an opaque mask 50 such as a chrome mask suitable for defining the respective ink channels including ink ejecting orifices is positioned during an ultraviolet exposure of the photoresist so that certain specific areas of the photoresist first layer 44 are subject to selective “curing.” Although not shown the mask may have clear areas and opaque areas as is well-known. In the selective curing, areas above the VCSEL windows are not cured in the areas of the photoresist first layer and additionally areas in the photoresist first layer which are to define the ink channels are also not cured. In this regard the term “cured” implies a physical difference results between the exposed and unexposed areas of the first layer due to the selective exposure thereof. The physical difference may be due to polymerization of the exposed areas or incipient polymerization which might result in differences in hardness between the exposed and unexposed areas either as a result of the exposure or as a result of the exposure in combination with a simultaneous or subsequent subjecting of the layer 44 to heat. Alternatively, the physical difference may be of the kind that results in differences in the layer when subject to a development process. In FIG. 6 a top view of the first layer 44 subsequent to exposure is illustrated wherein there are shown differences between the exposed and unexposed areas of the first layer, in this example the negative forming resist providing a different physical characteristic in the layer particularly above where the VCSEL laser window (and wherein the ink ejection cavity 40 in the first layer will be formed) is provided and at the location where the ink channel 45 in the first layer is ultimately to be formed.

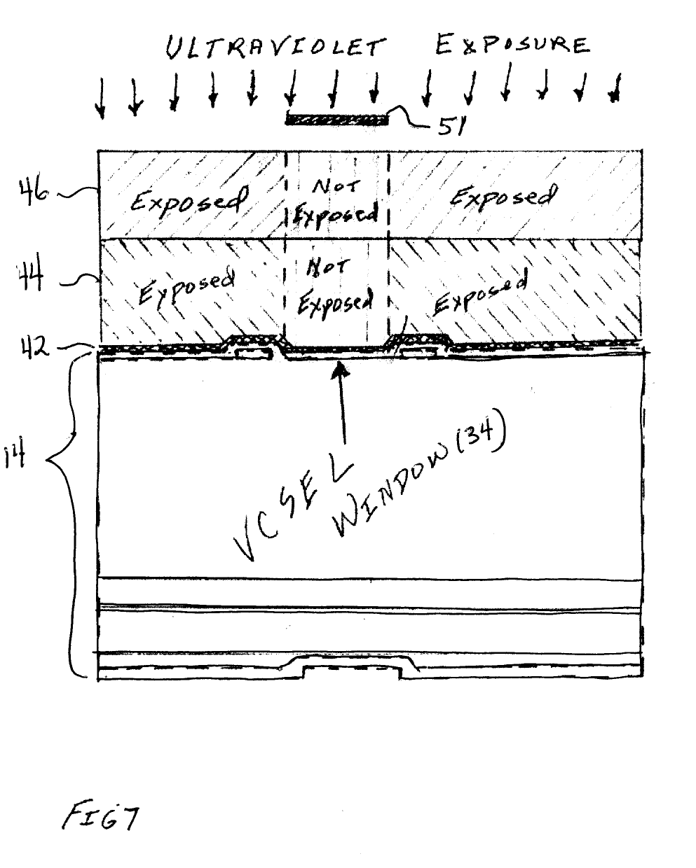

With reference now to FIG. 7 there is illustrated the structure of FIG. 5 with a photosensitive second photoresist layer 46 generally uniformly deposited or coated upon the first photoresist layer 44. The second layer 46 is deposited upon the first layer after the exposure of the first layer shown in FIG. 5 and FIG. 6 but before development of the first layer. The second photoresist layer 46 is preferably also a negative photoresist such as NR9-8000 (made by Futurex Inc. of Franklin, N.J.). The second layer may be coated to a thickness of between 10 micrometers and 25 micrometers. The purpose of the second photoresist layer is to “cap” or define the upper walls of the ink supply channels 45 to be formed in the first photoresist layer 44. The ultraviolet exposure of the second layer 46 is made with the second layer only masked by suitable mask 51 at the areas wherein the ink channel orifices 47 are to be formed and which overly the VCSEL windows 34 and not at the ink channel areas beyond the orifices locations. Both the SU-8 2000 and NR9-8000 photoresists have high absorption to exposure UV light at 365 nm where they each become cross-linked.

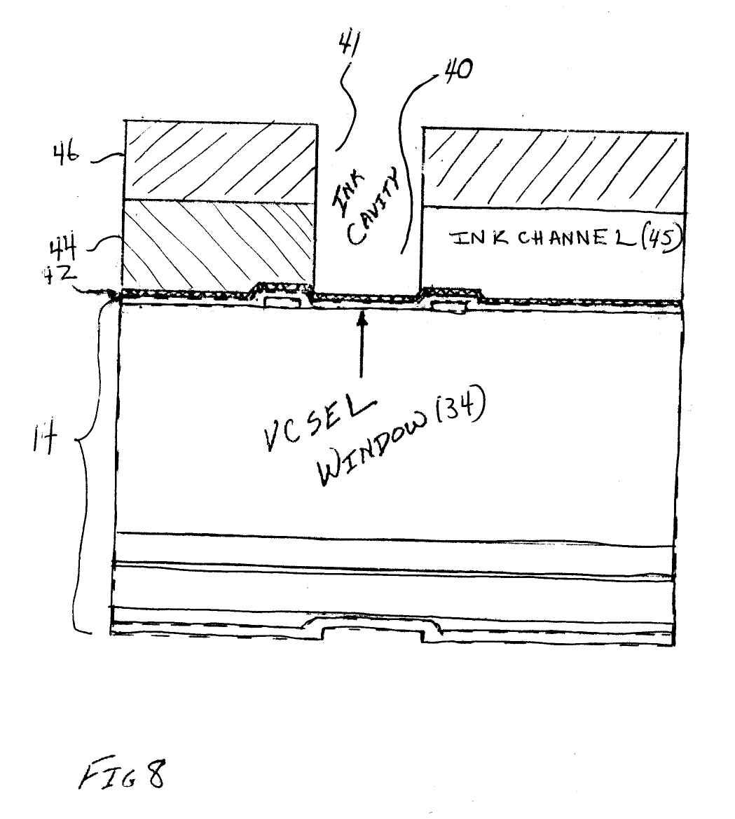

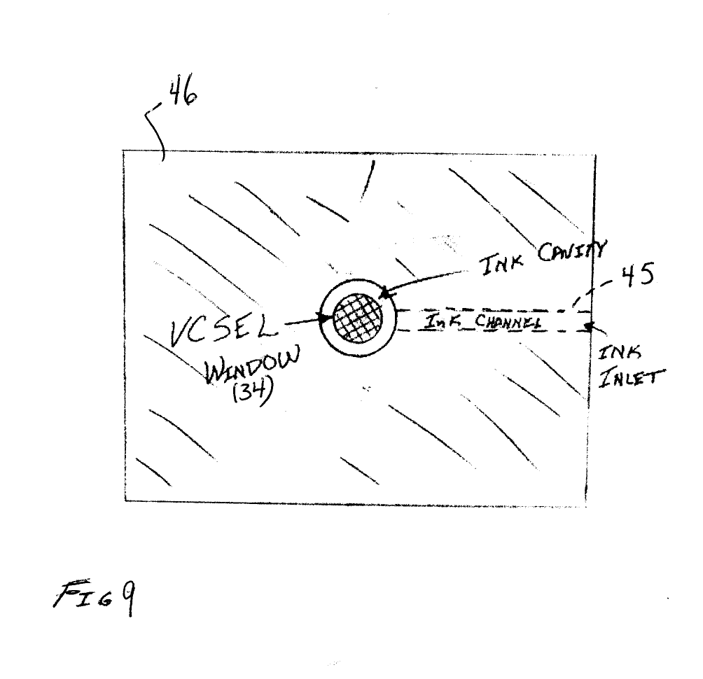

With reference now to FIG. 8 there is illustrated the cavities 40, 41 formed in the respective first and second layers 44, 46 respectively after their respective developments. Although the first layer 44 and second layer 46 are both negative photoresist layers, the polymers comprising the layers are of different types and subject to being developed by different types of developers. For example, the first layer 44 may be of the type subject to development with a non-aqueous solvent, such as cyclopentanone, whereas the second layer 46 may be of the type subject to development with an alkaline, aqueous solution. Alternatively, the first layer may be of the type subject to development with an aqueous solution whereas the second layer may be of the type subject to development with a non-aqueous solvent. The second layer 46 may be developed first with a first type of developer to provide the opening 41 through which the second developer may be deposited to develop the first layer 44. The SU-8 2000 photoresist used for the first layer 44 has the additional property in that unexposed resist which is solid at room temperature, becomes liquid at temperatures above 50° C. The low melting point allows removal of the SU-8 2000 in the ink channel by heating to 80° C. and applying 40 psi air pressure to the cavity. The developed NR9-8000 second layer 46 remains solid so that the underlying unexposed SU-8 2000 can be reflowed to form a channel under the NR9-8000 second layer 46. FIG. 9 is a top view of the printhead showing the ink channel formed in the first layer having top walls defined by the now hardened resist of the second layer 46 and sidewalls in the first layer 44.

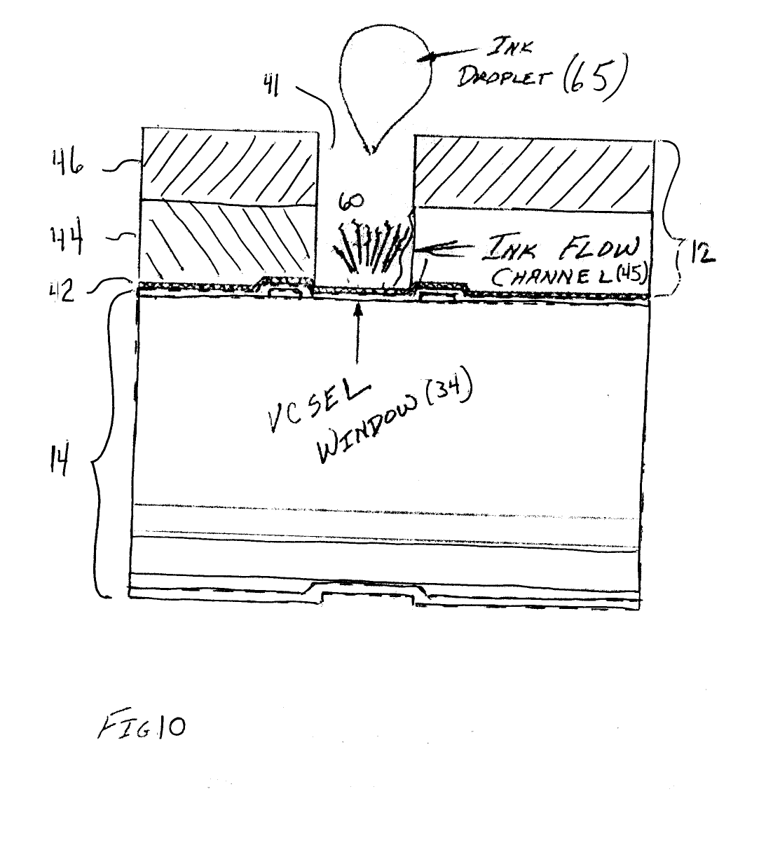

With reference now to FIG. 10 there is illustrated an example of operation of the printhead 11 for formation of an ink drop 65 wherein ink 60 located within the ink channel 45 associated with a respective laser actuator 30 and orifices 40, 41 in the first and second layers respectively in line with and overlying the respective actuator 30 is cause to be ejected from the orifices in response to activation of the laser to emit light and thereby heat up the ink within the orifices 40, 41 and cause a drop of the ink to be expelled from the orifices 40, 41 in accordance with known operations.

In the respective selective exposures of the first and second layers it will be understood that provision may also be made for selective removal of material from the first and second layers to provide for access of the electrical contacts 32 to suitable electrical connectors external to the printhead. Alternatively, electrical connectors, such as vias may be provided in the substrate 14 for connecting the electrical connectors to suitable connectors external to the printhead.

The ink ejecting orifices of the printhead 11 are preferably between approximately 25 microns and approximately 75 microns in diameter. The orifices are also preferably spaced by approximately 100 microns to approximately 500 microns from one another. Typically, the printhead 11 comprises approximately 20 to 50 ink ejecting orifices arranged in a line or sets of parallel lines, with corresponding ink channels. The laser diode windows 34 can additionally comprise one or more optical elements to shape the laser beam thereby facilitating the propagation of the laser light to liquid in the corresponding orifice. The laser diodes can be fabricated using semiconductor lithography technology.

There has thus been described an improved inkjet printhead and method of forming same. The inkjet printheads are characterized by relative ease of manufacture and/or with relatively planar surfaces to facilitate cleaning and maintenance of the printhead and a relatively thin insulating layer or layers, such as a passivation layer or layers, through which is formed the nozzle bore. The printhead described herein are suited for preparation in a conventional CMOS facility and the channels and nozzle bore may be formed in a conventional MEMS facility.

Although the present invention has been described with particular reference to various preferred embodiments, the invention is not limited to the details thereof. Various substitutions and modifications will occur to those of ordinary skill in the art, and all such substitutions and modifications are intended to fall within the scope of the invention as defined in the appended claims.

The invention has been described in detail with particular reference to certain preferred embodiments thereof, but it will be understood that variations and modifications can be effected within the spirit and scope of the invention.

1. A method of forming respective ink channels upon a substrate having respective actuators for providing energy to eject ink from the respective channels, the method comprising the steps of:
(a) depositing a first layer of uncured photoresist material of a first type onto a substrate incorporating the actuators;
(b) selectively exposing the first type of photoresist material on the substrate to form cured and uncured areas in the first type of photoresist material, wherein the uncured areas comprise the respective ink channels with respective orifices from which ink is to be ejected;
(c) depositing a second layer of photoresist material of a second type over the cured and uncured areas of the first type of photoresist material formed in step (b);
(d) selectively exposing the second type of photoresist material so as to provide uncured areas representing the respective orifices from which the ink is to be ejected and cured areas comprising channel walls for the respective ink channels;
(e) developing the second layer with a first developer that is suitable for developing the second layer but not suitable for developing the first layer;
(f) subsequent to step (e), developing the first layer with a second developer that is suitable for developing the first layer but not suitable for developing the second layer; and
(g) removing the undeveloped material in the first layer to form the respective ink channels with respective orifices for ejecting the ink.

2. The method of claim 1 and wherein the actuators are laser actuators.

3. The method according to claim 1 and wherein the substrate comprises a monolith that includes semiconductor material that defines a series of actuators adjacent one surface of the substrate.

4. The method according to claim 3 and wherein said one surface of the substrate is covered with a protective layer upon which the first layer is deposited.

5. The method according to claim 1 and wherein an aqueous solution is used to develop one of the first and second layers and a nonaqueous solvent is used to develop the other of the first and second layers.

6. The method according to claim 1 and wherein the undeveloped channel material is removed by heating and placing a pressure gradient so that liquid material comprising undeveloped channel material is forced out under pressure.

7. The method according to claim 1 and wherein the first layer is from 10 micrometers to 25 micrometers in thickness.

8. A printhead made in accordance with the method of claim 1.

9. A printhead made in accordance with the method of claim 2.
